(19) United States
(12) Patent Application Publication
(10) Pub. No.: US 2006/0253548 A1
(43) Pub. Date: Nov. 9, 2006

(54) Method and system for hosting and executing a component application

(75) Inventors: Kamen Vitanov, Mississauga (CA); Michael Shenfield, Richmond Hill (CA); Bridusa Fritsch, Toronto (CA); Viera Bibr, Kilbride (CA); Bryan Goring, Milton (CA)

Correspondence Address: Jonathan Pollack;Gowling Lafleur Henderson LLP, 1 First Canadian Place, Suite 1600, 100 King Street West, Toronto, ON, M5X 1G5, CA

(73) Assignee: RESEARCH IN MOTION LIMITED, WATERLOO (CA)

(21) Appl. No.: 11/405,494

(22) Filed: Apr. 18, 2006

Related U.S. Application Data
(60) Provisional application No. 60/672,241, filed on Apr. 18, 2005.

(51) Int. Cl. G06F 15/16

(52) U.S. Cl. 709/217

(57) ABSTRACT

A component application runtime environment is provided for executing component applications on a device comprising a native runtime environment for executing native applications. The component application runtime environment comprises the following services and subsystems. A control centre represents the component application runtime environment as a native application and provides features offered by the device to the component applications. A base services layer provides basic device services to the component applications. A messaging layer transmits messages to and from the component applications. An application layer provides user interfaces for executing the component application.

### APPLICATION

The present invention relates to a system and method for hosting and executing component applications on a computing device. This application claims priority from U.S. Provisional Application No. 60/672,241 filed Apr. 18, 2005.

### BACKGROUND

Due to the proliferation of wireless networks, there are a continually increasing number of wireless devices in use today. These devices include mobile telephones, personal digital assistance (PDAs) with wireless communication capabilities, two-way pagers and the like. Concurrently with the increase of available wireless devices, software applications running on such devices have increased their utility. For example, the wireless device may include an application that retrieves a weather report for a list of desired cities or an application that allows a user to shop for groceries. These software applications take advantage of the ability to transmit data of the wireless network in order to provide timely and useful services to users, often in addition to voice communication. However, due to a plethora of different types of devices, restricted resources of some devices, and complexity of delivering large amounts of data to the devices, developing software applications remains a difficult and time-consuming task.

Currently, devices are configured to communicate with Web Services through Internet based Browsers and/or native applications. Browsers have the advantage of being adaptable to operate on a cross-platform basis for a variety of different devices, but have a disadvantage of requesting pages (screen definitions in HTML) from the Web Service, which hinders the persistence of data contained in the screens. A further disadvantage of Browsers is that the screens are rendered at runtime, which can be resource intensive. Applications for browsers are efficient tools for designing platform independent applications. Accordingly, different runtime environments, regardless of the platform, execute the same application. However, since different wireless devices have different capabilities and form factors, the application may not be executed or displayed as desired. Further, browser based applications often require significant transfer bandwidth to operate efficiently, which may be costly or even unavailable for some wireless devices.

On the other hand, native applications are developed for a specific wireless device platform, thereby providing a relatively optimized application program for a runtime environment running on that platform. However, a platform dependent application introduces several drawbacks, including having to develop multiple versions of the same application and being relatively large in size, thereby taxing memory resources of the wireless device. Further, application developers need experience with programming languages such as Java and C++ to construct such native applications.

Accordingly, there is a need for an application infrastructure that overcomes or improves on the limitations described above. As part of such an infrastructure, there is a need for a runtime environment configured to host and execute applications on the wireless device.

### BRIEF DESCRIPTION OF THE DRAWINGS

Embodiments of the present invention will now be described by way of example only with reference to the following drawings in which:

FIG. 1 is a schematic diagram of a communication infrastructure;

FIG. 2 is a schematic diagram of a runtime environment;

FIG. 3 is a block diagram illustrating interaction with the control centre;

FIG. 4 is a block diagram illustrating interaction with the screen subsystem;

FIG. 5 is a block diagram illustrating interaction with the interpreter subsystem;

FIG. 6 is a block diagram illustrating the metadata subsystem in greater detail;

FIG. 7 is a block diagram illustrating interaction with the metadata subsystem;

FIG. 8 is a block diagram illustrating interaction with the access subsystem;

FIG. 9 is a block diagram illustrating interaction with the RE container;

FIG. 10 is a block diagram illustrating interaction with the discovery subsystem;

FIG. 11 is a block diagram illustrating interaction with the provisioning subsystem;

FIG. 12 is a block diagram illustrating interaction with the lifecycle subsystem;

FIG. 13 is a block diagram illustrating interaction with the messaging subsystem;

FIG. 14 is a block diagram illustrating interaction with the persistence subsystem;

FIG. 15 is a block diagram illustrating interaction with the security subsystem;

FIG. 16 is a block diagram illustrating interaction with the communication subsystem;

FIG. 17 is a flow diagram illustrating initializing of the runtime environment;

FIG. 18 is a flow diagram illustrating receipt of an incoming message;

FIG. 19 is a flow diagram illustrating receipt of an incoming component application message;

FIG. 20 is a flow diagram illustrating transmitting an outgoing message;

FIG. 21 is a flow diagram illustrating installation of a runtime environment upgrade;

FIG. 22 is a flow diagram illustrating starting a component application; and

FIG. 23 is a flow diagram illustrating a user initiated provision request.

### DETAILED DESCRIPTION OF THE PREFERRED EMBODIMENTS

In accordance with one embodiment there is provided a device capable of executing component applications, the device comprising a native runtime environment for executing native applications and a component application runtime environment for executing the component applications, the component application runtime environment comprising: a control centre for representing the component application runtime environment as a native application and for providing features offered by the device to the component applications; a base services layer for providing basic device services to the component applications; a messaging layer for transmitting messages to and from the component applications; and an application layer for providing user interfaces for executing the component application.

In accordance with a further embodiment there is provided a component application runtime environment for executing component applications on a device, the device comprising a native runtime environment for executing native applications, the component application runtime environment comprising: a control centre for representing the component application runtime environment as a native application and for providing features offered by the device to the component applications; a base services layer for providing basic device services to the component applications; a messaging layer for transmitting messages to and from the component applications; and an application layer for providing user interfaces for executing the component application.

In accordance with yet a further embodiment there is provided a method for executing a component application in a component application runtime environment executing on a host device, the method comprising the steps of: receiving a request for a target component application; loading corresponding component application metadata into the component application runtime environment; processing any message pending for the target component application; running any available start-up scripts for the target component application; and presenting a main screen component on the device screen.

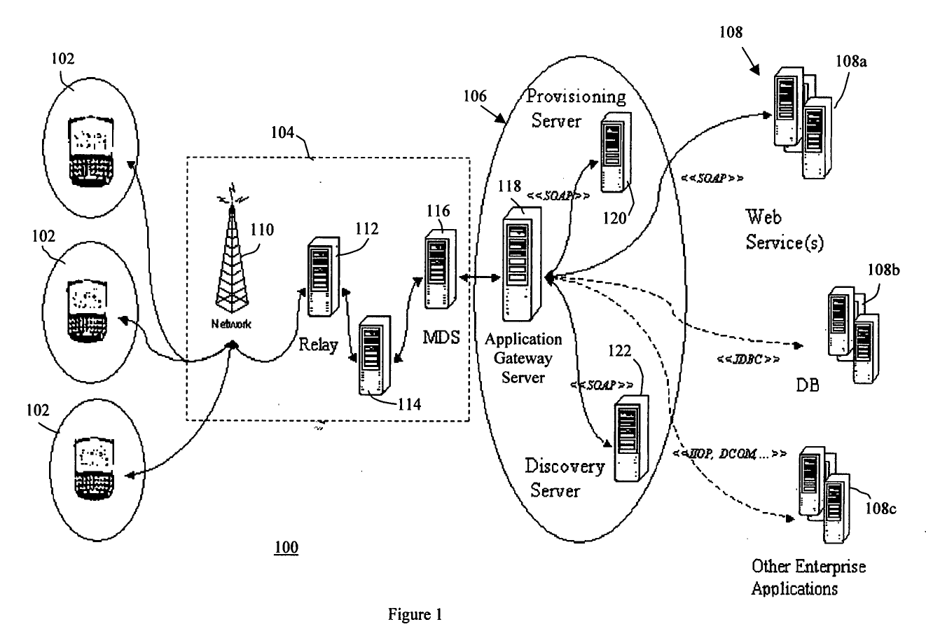

For convenience, like numerals in the description refer to like structures in the drawings. Referring to FIG. 1, a communication infrastructure is illustrated generally by numeral 100. The communication infrastructure 100 comprises a plurality of communication devices 102, or simply devices 102, a communication network 104, an application gateway 106 and a plurality of backend servers 108.

The devices 102 include both wired and wireless computing devices such as a desktop computer, a laptop or other portable computer, a smart phone, a personal digital assistant (PDA), and the like. The devices 102 are in communication with the application gateway 106 via the communication network 104. Accordingly, the communication network 104 may include several components such as a wireless network 110, a relay 112, a corporate server 114 and/or a mobile data server 116 for relaying data between the devices 102 and the application gateway 106.

The application gateway 106 comprises a gateway server 118 a provisioning server 120, a discovery server 122 and a repository 124. The gateway server 118 is in communication with both the provisioning server 120 and the discovery server 122. The gateway server 110 is further in communication with a plurality of the backend servers 108, such as web services 108a, database services 108b, as well as other enterprise services 108c, via a suitable link. For example, the gateway server 110 is connected with the web services 108a and database services 108b via Simple Object Access Protocol (SOAP) and Java Database Connectivity (JDBC) respectively. Other types of backend servers 108 and their corresponding links will be apparent to a person of ordinary skill in the art. Accordingly, it can be seen that the gateway server 118 acts as a message broker between the devices 102 and the backend servers 108.

Each wireless device 102 is initially provisioned with a service book establishing various protocols and settings, including connectivity information for the corporate server 114 and/or the mobile data server 116. These parameters may include a Uniform Resource Locator (URL) for the application gateway server 118 as well as its encryption key. Alternately, if the wireless device 102 is not initially provisioned with the URL and encryption key, they may be pushed to the wireless device 102 via the mobile data server 116. The mobile device 102 can then connect with the application gateway 106 via the URL of the application gateway server 118.

Applications are provided for execution on the wireless devices 102. The applications are stored in a repository 124 as a series of packages, or bundles. The packages are typically created by an application developer using a design tool provided by the application development environment.

The availability of application packages in the repository 124 is published in a registry via a discovery service provided by the discovery server 122. It is recognized that there can be more than one repository 124 and associated registries used by the gateway server 118.

Once initialized, the device 102 can access applications stored in the repository 124 by actively downloading the application or having the application pushed to it via the gateway server 118.

In the present embodiment, the applications described above are component applications. A component application is an application defined generally by a structured set of components, including data components, message components, presentation components and workflow components. The components are defined using a structured language and executed on a client device by an intelligent runtime container.

The data components define data entities that are used by the component application program. Examples of data entities include orders, users, and financial transactions. Data components define what information is required to describe the data entities, and in what format the information is expressed. For example, the data component may define an order comprising a unique identifier for the order which is formatted as a number, a list of items which are formatted as strings, the time the order was created which has a date-time format, the status of the order which is formatted as a string, and a user who placed the order which is formatted according to the definition of another one of the data components. Since data elements are usually transferred by message, there is often persistence of data components in a database. Data components may be dynamically generated or defined by the application designer.

The message components define the format of messages used by the component application program to communicate with external systems such as the web service. For example, one of the message components may describe a message for placing an order, which includes a unique identifier for the order, a status of the order, and notes associated with the order.

The presentation components define the appearance and behaviour of the component application program as it displayed to a user via a user interface. The presentation components can specify graphical user interface (GUI) screens and controls, and actions to be executed when the user interacts with the component application. For example, the presentation components may define screens, labels, edit boxes, buttons and menus, and actions to be taken when the user types in an edit box or pushes a button.

The workflow components of the component application program define processing that occurs when an action is to be performed, such as an action specified by a presentation component as described above, or an action to be performed when messages arrive. Presentation workflow and message processing are defined by the workflow components. The workflow components are written as a series of instructions in either metadata or a programming language or a scripting language. The workflow component supports a correlation between message components and defines application flow as a set of rules for operations on other components.

More details regarding component application can be found in Patent Cooperation Treaty Application Numbers PCT/CA2003/001976, PCT/CA2003/001980 and PCT/CA2003/001981. titled “System and Method for Building and Execution of Platform-Neutral Generic Services Client Applications”, “System and Method of Building Wireless Component Applications” and “System and Method of Creating and Communicating with Component Based Wireless Applications”, respectively.

In order to execute component applications as described above, the devices are provided with a component application runtime environment (also referred to simply as runtime environment) in accordance with the present invention. This runtime environment differs from a device's native operating system, which will be referred to as native runtime environment.

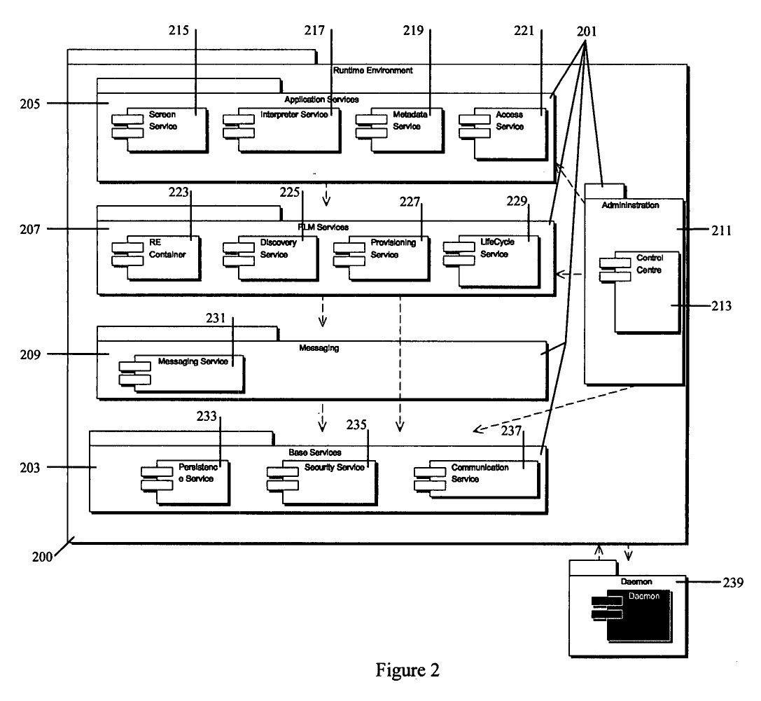

Referring to FIG. 2, a runtime environment in accordance with an embodiment of the invention is illustrated generally by numeral 200. The runtime environment 200 includes four layers of service; a base services layer 203, a messaging layer 209, a product lifecycle management (PLM) services layer 207 and an application services layer 205. The runtime environment 200 further includes an administration service 211. The administration service 211 further includes a control centre 213. A daemon 239 is in communication with the runtime environment 200.

At the lowest level, the base services layer 202 offers basic, domain independent system services to other components in higher levels. Thus, for example, all subsystems in the messaging layer 209, the PLM services layer 207 and the application services layer 205 can utilize and collaborate with the subsystems in the base services layer 203. In the present embodiment, the base services layer 203 includes a persistence subsystem 233, a security subsystem 235 and a communication subsystem 237.

The messaging layer 209 is the next layer up from the base services layer 203. The messaging layer 209 provides message services for transmitting messages to and from the applications. All subsystems in the PLM services layer 207 and the application services layer 205 can utilize and collaborate with the subsystems in the messaging layer 209. In the present embodiment, the messaging layer 209 includes a messaging subsystem 231.

The PLM services layer 207 is the next layer up from the messaging layer 209. The PLM services layer 207 provides many of the application maintenance and lifecycle requirements for the applications. All subsystems in the application services layer 205 can utilize and collaborate with the subsystems in the PLM services layer 207. In the present embodiment, the PLM service layer 207 includes a runtime environment (RE) container 223, a discovery subsystem 225, a provisioning subsystem 227 and a lifecycle subsystem 229.

The application services layer 205 sits at the top of the architecture and provides external program interfaces and user interfaces for executing the application using its subsystems as well as those provided by the lower layers 207, 209 and 203. In the present embodiment, the application services layer 205 includes a screen subsystem 215, an interpreter subsystem 217, a metadata subsystem 219 and an access subsystem 221.

Control Centre 213

The control centre 213 represents the runtime environment 200 as a standard application to other standard applications that may be executing on the device 102 in the native runtime environment. If one of the other standard applications needs to invoke a component application, it can do so by communicating with the control centre 213 using predefined parameters. Such parameters will be apparent to a person skilled in the art and may include, for example, a component application identifier. The control centre 213 acts as an interface between the standard application and the component application executing in the runtime environment 200.

The control centre 213 further integrates the runtime environment 200 with other features provided by the device's operating system to help reduce duplication. For example, the control centre 213 integrates features such browser support, electronic mail (e-mail) support, device settings and an application switcher or toggler with the runtime environment.

As such, the control centre 213 processes user interactions within the runtime environment that affect device features. Examples of such features include main menu handling, menu navigation, keyboard input and device status indicators such as signal strength, new messages, battery life and the like.

In order to achieve its responsibilities, the control centre 213 collaborates with a number of the subsystems in the runtime environment 200. The collaboration is achieved in terms of message sending, object method invocations and any other possible means hereafter abstracted as requests.

For example, the control centre 213 collaborates with the messaging subsystem 231 for retrieving a pending incoming/outgoing message count, per application component. Additionally the two subsystems 213 and 231 can collaborate to delete pending outgoing messages for a specific component application or to delete all pending outgoing messages.

The control centre 213 collaborates with the persistence subsystem 233 for storing and retrieving configuration data as well statistics about the space available in the persistent store.

The control centre 213 collaborates with the lifecycle subsystem 229 for starting, deleting, renaming a component application or retrieving its related information.

The control centre 213 collaborates with the provisioning subsystem 227 for starting or cancelling provisioning. Additionally, the provisioning can be sent to the background.

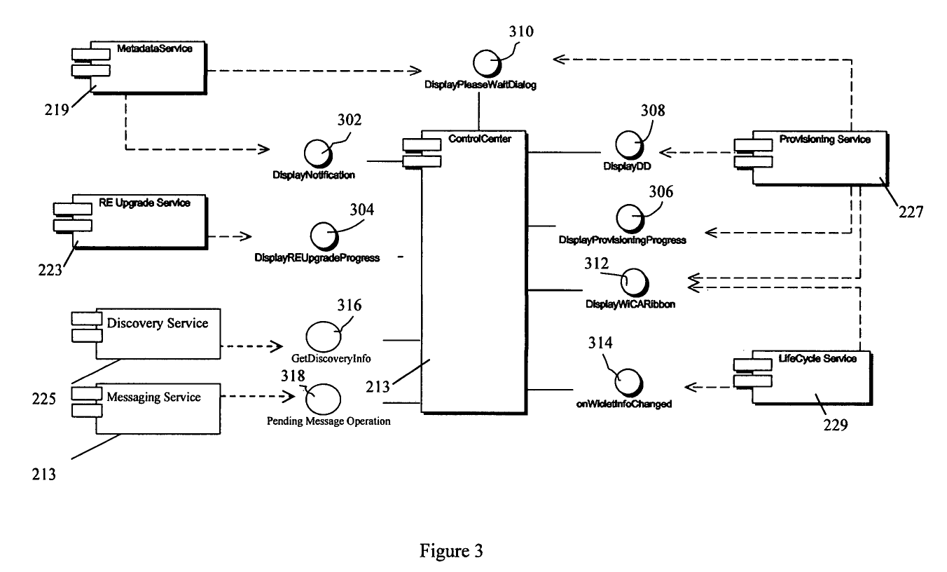

Referring to FIG. 3, interaction with the control centre 213 is shown in greater detail. As illustrated, the control centre 213 includes a number of application program interfaces (APIs) for facilitating communication with different services and subsystems. In the present embodiment the APIs include a notification interface 302, an upgrade interface 304, a provisioning progress interface 306, a deployment descriptor interface 308, a waiting dialog interface 310, an icon interface 312, and an information change interface 314. Typically, each of the interfaces can be accessed by an API call from a corresponding service or subsystem.

The notification interface 302 provides the ability to notify the user of a particular event. The notification interface 302 can be used to provide the user with a visual indicator and/or an audio indicator, depending on a notification level of the event. As described above, the control centre 213 is an interface to the features already made available by the device. Therefore, the control centre 213 can take advantage of these features to present the notification to the user.

For example, the metadata subsystem 219 can advise the control centre 213 via the notification interface 302 that updated information has been received and that the user is to be notified. In response, the control centre 213 advices the user by presenting a dialog or audible alarm using notification features provided by the device 102.

The upgrade interface 304 provides the ability to visualize progress of an upgrade of the runtime environment 200. For example, the RE container 223 provides the user with the ability to upgrade the runtime environment 200. The RE container 223 can communicate the status of the upgrade with the user via the upgrade interface 304. The control centre 213 provides the user with a visual display regarding the upgrade. If the user chooses to proceed, the user is provided with a visual display illustrating the status of the upgrade and the option to cancel or postpone the upgrade.

The provisioning progress interface 306 provides the ability to visualize progress of provisioning a component application onto the device 102. For example, the provisioning subsystem 227 can communicate the status of the component application provisioning with the user via the provisioning progress interface. Similarly to the case described above, the control centre 213 provides the user with a visual display regarding the status of the provisioning as well as the option to cancel or postpone the provisioning process.

The deployment descriptor interface 308 provides the ability to display deployment descriptor information for an application to be provisioned. For example, the provisioning subsystem 227 communicates with the control centre 213 via the deployment descriptor interface 308 for providing the user with a dialog to indicate that a component application is to be provisioned. The user can accept or cancel the provisioning of the component application and the user's response is returned to the provisioning subsystem 227.

The wait dialog interface 310 provides an indication to the user via the control centre 213 that a time consuming operation is being executed and the runtime environment is waiting for a result. The indication can be in the form of a dialog or the alteration of a cursor on the display of the device 102. For example, the runtime environment may be waiting if the provisioning subsystem 227 is provisioning an application or contacting the application gateway server 118 to locate a component application defined by a deployment descriptor. Similarly, the runtime environment may be waiting for the metadata subsystem 219 to process information.

The icon interface 312 provides an application icon on the display of the device 102 via the control centre 213 to indicate the presence of a component application and to enable the user to access the application. Accordingly, once the provisioning subsystem 227 has provisioned an application on the device 102, an icon representing the application is provided via the icon interface 312 for display by the device. Similarly, the lifecycle subsystem 229 can use the icon interface 312 to update the icon if it changes in a subsequent component application upgrade or if the icons are user selectable.

The information change interface 314 provides the user with notification that information or status of a component application has changed. The control center 213 determines the change and update component application's icon accordingly. For example, it will be appreciated that events such as notifications may be displayed to the user by altering the icon representing the component application in addition to or instead of using the notification interface 302.

Screen Subsystem 215

The screen subsystem 215 provides a display interface between a currently running component application and the user. The screen subsystem 215 renders the display interface on the device display, maintains a component application user interface context, handles the user's input within this context and manages the component application screen workflow.

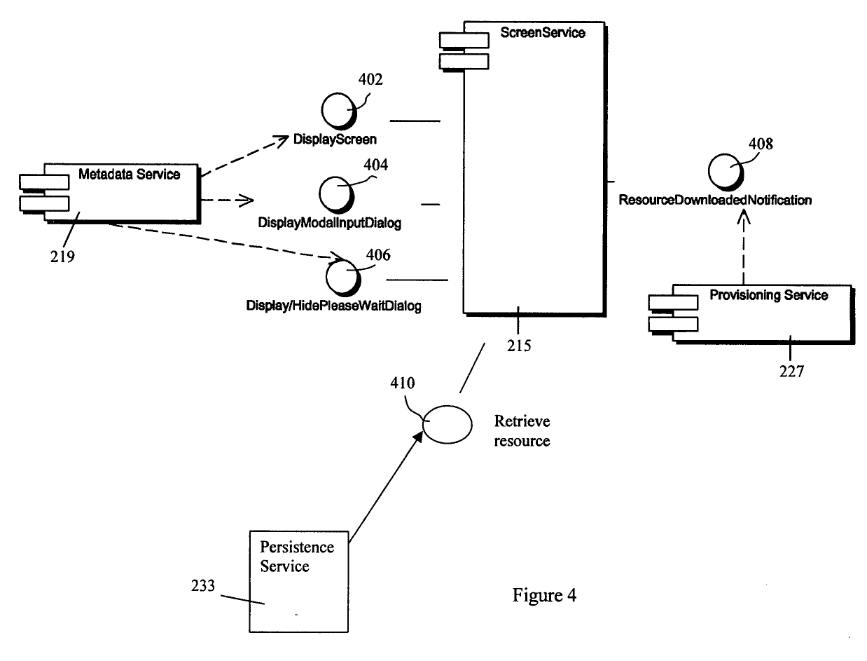

Referring to FIG. 4, interaction with the screen subsystem 215 is shown in greater detail. As illustrated, the screen subsystem 215 includes a number of APIs for facilitating communication with different services. In the present embodiment the APIs include a screen display interface 402, an input dialog interface 404, a wait dialog interface 406, a downloaded notification interface 408 and a resource retrieval interface 410.

The screen display interface 402 is used to refresh a current screen or present a new screen on the display of the device 102 via the screen subsystem 215. For example, the metadata subsystem 219 can request a screen refresh if data changes so that the new data is displayed to the user. The screen service 215 determines the change and refreshes the screen accordingly.

The input dialog interface 404 is used for providing the user with an input dialog box to obtain user input. For example, the metadata subsystem 219 can request a user interaction in response to a data change. The screen subsystem 215 displays a modal input dialog and captures the user's response.

The wait dialog interface 406 provides an indication to the user via the screen subsystem 215 that a time consuming operation is being executed and the runtime environment is waiting for a result. The indication can be in the form of a dialog or the alteration of a cursor on the display of the device 102. For example, if the metadata subsystem 219 is processing information it advises the screen subsystem 215 via the wait dialog interface 406. The screen subsystem 215 presents the indication to the user that the system is busy.

The downloaded notification interface 408 provides an indication to the user that a desired resource or component application has been retrieved. For example, the provisioning subsystem 227 indicates to the screen subsystem 215 that a component application has been downloaded via the downloaded notification interface 408. The screen subsystem 215 presents this information to the user.

The resource retrieval interface 410 provides the screen subsystem 215 with access to data stored in the persistence subsystem 233 for presentation to the user.

Interpreter Subsystem 217

The interpreter subsystem 217 provides a proper execution environment for the component applications, executes JavaScript™ code fragments and provides code fragments with access to functionality provided by the rest of the services in the runtime environment 200 via access to the metadata subsystem 219.

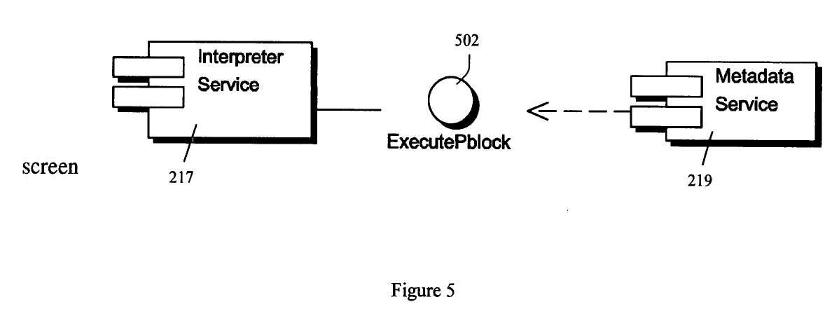

Referring to FIG. 5, interaction with the interpreter subsystem 217 is shown in greater detail. The interpreter subsystem 217 may include a number of interfaces for facilitating communication with different services. In the present embodiment the interfaces include an execute code fragment interface 502. The execute code fragment interface 502 is used to facilitate communication between the interpreter subsystem 217 and the metadata subsystem 219 when executing a JavaScrip™ code fragment in the context of a displayed screen.

Metadata Subsystem 219

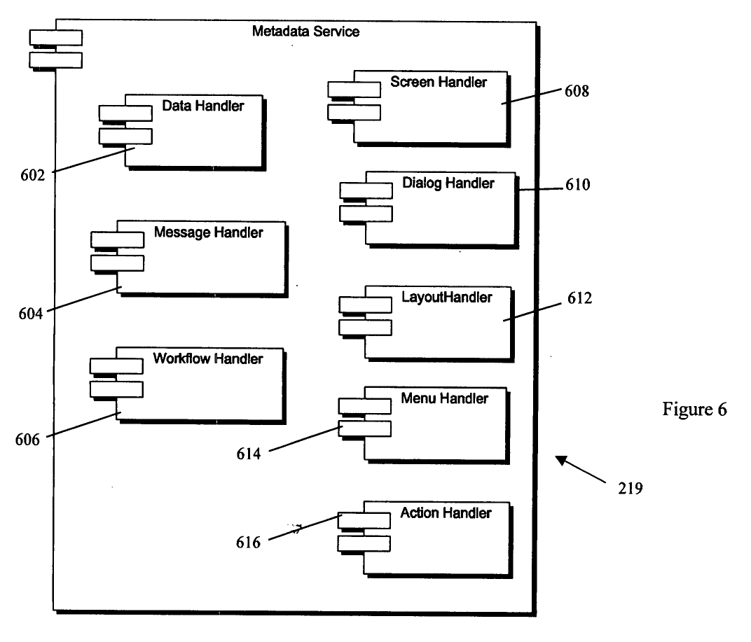

Referring to FIG. 6, the metadata subsystem 219 is illustrated in greater detail. The metadata subsystem 219 handles and mediates all component application metadata related access. In order to facilitate this, the metadata subsystem 219 comprises a data handler 602, a message handler 604, a workflow handler 606, a screen handler 608, a dialog handler 610, a layout handler 612, a menu handler 614 and an action handler 616.

The data handler 602 manages data access to the data component of the component application. Data access between an executing component application and the data stored in the device memory is facilitated by the persistence service 233.

The message handler 604 handles incoming component application messages by correlating the messages with an appropriate handler. For example, data received in a message is mapped to a corresponding data component and updated via the data handler 602. Additionally, if the message requires processing a code fragment, the action handler 616 is invoked. If a screen refresh or an alert is required, the screen handler 608 is invoked. The message handler 604 also handles outgoing component application and service messages.

The workflow handler 606 handles workflow management as defined by the workflow component of the component application.

The screen handler 608 processes screen definitions defined by the component application. The screen handler 608 employs the dialog handler 610, the layout handler 612 and the menu handler 614. The layout handler 612 processes the screen layouts and controls with conditions and mapping. The dialog handler 610 processes dialogs presented to the user. The menu handler 614 processes the screen menus.

The action handler 616 handles script management as defined scripts of the component application.

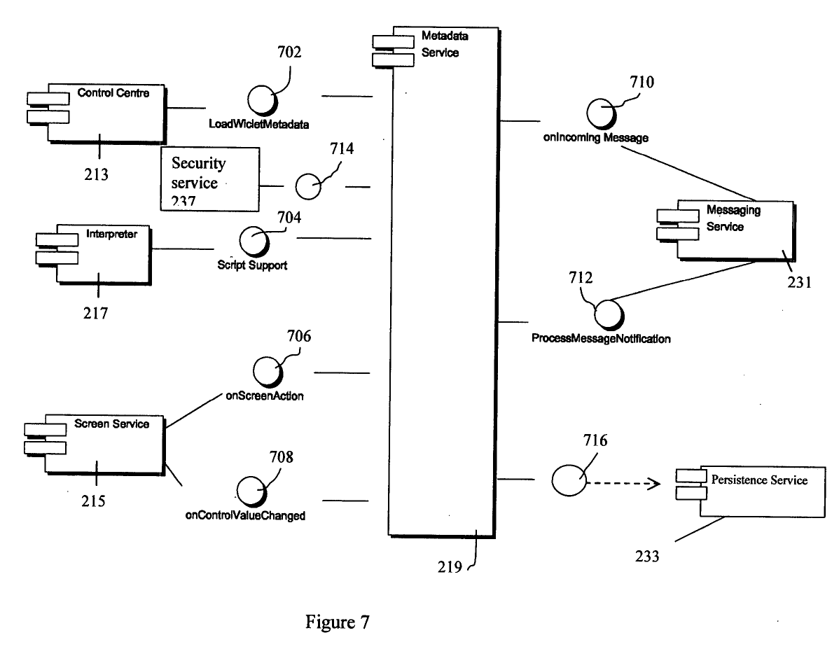

Referring to FIG. 7, interaction with the metadata subsystem 219 is shown in greater detail. As illustrated, the metadata subsystem 219 includes a number of interfaces for facilitating communication with different services. In the present embodiment the interfaces include a load metadata interface 702, a script support interface 704, a screen action interface 706, a value changed interface 708, and incoming message interface 710, a message notification interface 712, a security interface 714 and an access interface 716.

Thus, for example, if a component application is to be loaded, the control centre 213 retrieves the required metadata via the load metadata interface 702.

The script support interface 704 provides the interpreter subsystem 217 with access to the metadata subsystem 219 in order to facilitate execution of scripts that require metadata access. Further the script support interface 704 facilitates executing a script in response to a metadata change.

The screen action and value changed interfaces 706 and 708 provide the screen service 215 with access to the metadata subsystem 219 as required. Specifically, the screen action interface 706 facilitates providing metadata in response to a screen action initiated by a user. The value changed interface 708 facilitates providing updated metadata for an existing screen to be refreshed when data on that screen has changed. Further, the screen action and value changed interfaces 706 and 708 provide the ability to refresh screen controls or display a modal dialog box.

The incoming message and message notification interfaces 710 and 712 provide the messaging subsystem 231 with access to the metadata subsystem 219 as required. Specifically, the incoming message interface 710 provides an interface for the messaging subsystem 231 to update metadata in accordance with incoming messages. The message notification interface 712 provides an interface for the messaging subsystem 231 to update metadata in accordance with incoming notifications.

The security interface 714 provides an interface with the security subsystem 235 for facilitating security verification. For example, the security service 235 can be used to validate a request by the component application to send a message. As another example, the security service 235 can be used to validate a request to the access subsystem 221. As will be described in detail, the access subsystem 221 allows component applications to access other applications executing on the wireless device 102.

The persistence interface 716 provides an interface with the persistence subsystem 233 facilitating access to the device memory. Accordingly, the metadata subsystem 219 is provided with the ability to retrieve a resource; create, update or delete data; and update global data.

Access Subsystem 219

The access subsystem 219 allows component application to access other non-component application executing on the device 102. The access subsystem architecture allows a plug-in of a specific device application handler having an application identifier. The application identifier is published in the access subsystem's namespace and used by the component application to access an application via the application handler.

The type of access between a component application and a non-component application can generally be categorized as data access and execution/call access.

Data access can be provided for facilitating read and/or write access to information maintained by another application. For example, access to data managed by a non-component application on the device 102, such as an Address Book, is handled using data components. The metadata subsystem 219 recognizes external fields required for the data component and requests that the access subsystem 221 retrieve this information.

Execution/call access can be provided for facilitating execution of functionality provided by another application. For example, access to functionality provided by a non-component application on the device 102, such as telephone service, is provided. The access subsystem 221 executes the requested non-component application functionality on behalf of the component application.

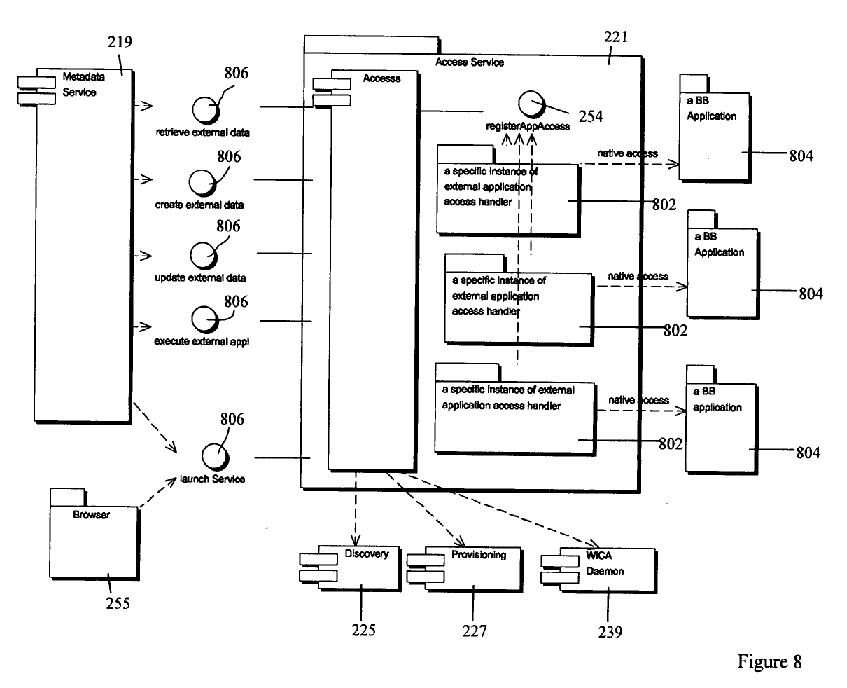

Referring to FIG. 8, interaction with the access subsystem 219 is shown in greater detail. As illustrated, specific instances of a non-component application handler 802 is generated for each non-component application 804 with which communication is desired. The application handler 802 can communicate with its corresponding non-component application 804 using native commands.

In order to implement its responsibilities, the access subsystem 221 collaborates with the non-component applications 804. In the present embodiment, such non-component applications 802 include calendar, address book, tasks, memo, device information, electronic-mail (e-mail), telephone, and Web-browser applications. The collaboration is achieved in terms of message sending, object method invocations and the like.

The access subsystem 221 further collaborates with the metadata subsystem 219 for facilitating communication with the non-component application 802. For example, the access subsystem 221 creates a data representation for the data components. Then, when a function call is received from a component application, the component application's data components are converted and supplied as parameters of a function call to non-component applications. Conversely, objects returned by a non-component application function call are converted to data component compatible form.

Accordingly, a number of interfaces 806 are provided to facilitate communication between the metadata subsystem 219 and the access subsystem 221. The following is a list of exemplary interfaces 806 for facilitating communication. In the present embodiment, each of the interfaces 806 are made available using an Application Program Interface (API) call. A retrieve collection interface returns a collection of data items from a non-component application on the device 102 in response to a given list of desired unique identifiers (UIDs). A retrieve where interface returns a collection of data items from non-component applications on the device 102 in response to a matching WHERE clause. A retrieve all interface retrieves all homogenous data instances from a non-component application on the device 102. A retrieve-by-primary-key interface finds a specific instance of a data component by matching a primary key from a non-component application on the device 102. An edit interface creates, modifies, or deletes a data instance managed by a non-component application on the 102 device. An execute non-component application interface executes non-component applications on the device 102 and can be used, for example, to play a sound, make a phone call, send e-mail, launch a Web-browser and the like. An execute component application service interface launches the provisioning 227, discovery 225 or daemon 239 subsystems.

RE Container 223

The RE container 223 coordinates component application runtime environment upgrade and backup/restore processes. The RE container 223 also implements a default error handling mechanism.

The RE upgrade process includes downloading relevant upgrade files in their native file-format, as well installing the upgrades from these files. The native file-format used depends on the operating system of the wireless device. For example, Blackberry™ devices provided by Research in Motion™ currently execute COD files on their operating system.

The backup/restore mechanism provides the ability to backup and restore the RE and installed component application on persistent media of another device, such as a desktop computer. Further, the backup/restore functionality allows the RE to be backed up from one device and the backed up image to be restored onto another device.

The default error handling mechanism provides a default error handler for critical conditions that arise during execution of the RE. These condition include, for example, critical errors in RE services, low memory condition, RE initialization failure, security related failure such as invalid signatures and the like, and availability error of the application gateway 106.

In order to facilitate its responsibilities, the RE container 223 collaborates with a device backup/restore low-level API, as well as the communication subsystem 237, the messaging subsystem 231, the control centre 213, the lifecycle subsystem 229, the security subsystem 235 and the persistence subsystem 233. The collaboration is achieved by message transmissions, object method invocations and the like, hereafter referred to as requests.

The RE container 223 collaborates with the device backup/restore low-level API to provided backup and restore features for the installed component applications. As such, the RE container can backup and/or restore the RE and all component application data and metadata.

The RE container 223 registers with the communication subsystem 237 as a coverage-listener for receiving information. Also, the RE container collaborates with the communication subsystem 237 for retrieving native file-format files, for example, for upgrading the RE.

The RE container 223 also registers with the messaging subsystem 231 as listener for RE related system messages. Such messages include, for example; RE upgrade result response, RE version response; and RE device swap notification.

The RE container 223 collaborates with the control centre 213 for providing relevant RE upgrade information to the user. For example, the user may be provided with a prompt indicating that an upgrade is required. Further, various status updates related to the RE upgrade progress may be provided via the control centre 213. Once an upgrade is successfully completed, a restart of the device 102 may be required, and the user is notified accordingly.

The security subsystem 235 provides verification such as validation of the files required for the RE. The persistence subsystem 233 provides the RE container 223 with the ability to temporarily store native file-format files. Further, it provides the RE container 223 with the ability to retrieve and save all data that needs to be backed up and/or restored.

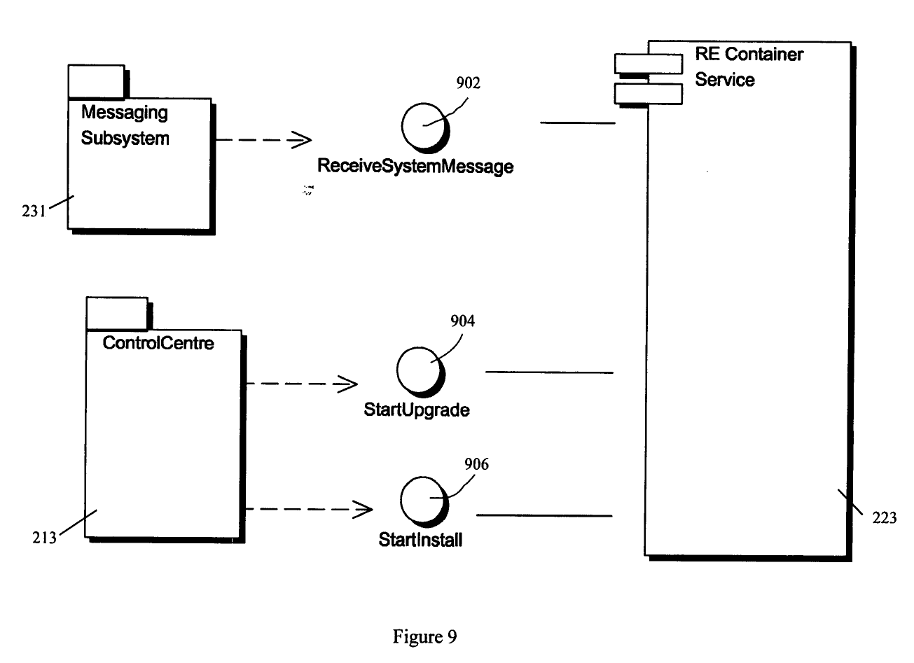

Referring to FIG. 9, interaction with the RE container 223 is illustrated generally by numeral 900. A message received interface 902 provides an interface between the RE container 223 and messaging subsystem 231. The message received interface 902 notifies the RE container 223 that a system message for which it is registered has arrived. Example of such messages include messages indicating that an RE upgrade is available, an RE upgrade is requested, or a version of a particular RE is queried.

An upgrade-start interface 904 and an upgrade-install interface 906 provide an interface between the control centre 213 and the RE container 223. The upgrade-start interface 904 initiates the process of upgrading the RE, including notifying the user, obtaining the required files and the like. Once all the necessary steps have been taken, the upgrade-install interface 906 provides the initiation of the actual upgrade-install process. The install process initiated through this interface 906 involves, for example, converting a component application's metadata, data and pending messages to a structured language (such as XML), installing the downloaded RE upgrade files, and restarting the device 102

Discovery Subsystem 225

The discovery subsystem 225 provides the device RE with a means for discovery of component applications located in an application repository. The discovery is performed by sending query request messages to the application repository, which is hosted on an external server in the present embodiment.

It is envisioned that the discovery process can be customized by a discovery component application. Accordingly, the discovery subsystem 225 would service such a component application. The discovery component application could communicate with the discovery subsystem 225 by sending service messages.

In order to facilitate implementation of its responsibilities, the discovery subsystem 225 collaborates with the messaging subsystem 231 and the control centre 213. The collaboration is achieved using requests. The discovery subsystem 225 collaborates with the messaging subsystem 231, for example, by sending discovery service messages. In the case where a discovery component application is used, a message is sent to the discovery component application.

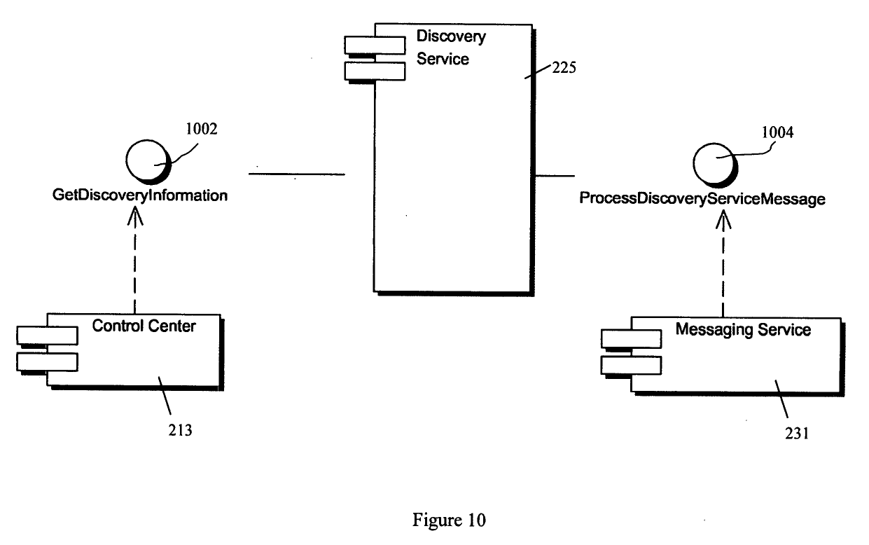

Referring to FIG. 10, interaction with the discovery subsystem 225 is illustrated generally by numeral 1000. In order to facilitate communication, two interfaces are provided; a discovery information interface 1002 and a discovery message interface 1004.

The discovery information interface 1002 facilitates transmission of a discovery request query to the application repository. The discovery message interface 1004 processes service messages, including discovery error messages and messages from discovery component applications.

Provisioning Subsystem 227

The provisioning subsystem 227 provides mechanism for provisioning component applications on the device 102. The act of provisioning a component application includes downloading, installing and/or upgrading the application. Both the device user as well as the application gateway 106 can initiate provisioning. The provisioning subsystem 227 allows for customized provisioning that can be provided using a provisioning component application on the device.

In order to facilitate implementing its responsibilities, the provisioning subsystem 227 collaborates with the messaging subsystem 231, the lifecycle subsystem 229, the persistence subsystem 233, the communication subsystem 237 and the control center 213. The collaboration is achieved using requests.

The provisioning subsystem 227 collaborates with the messaging subsystem 231 by registering as a listener for provisioning related system messages, such as component application upgrade required and/or available. The provisioning subsystem 227 further has the ability to send service messages related to the component application provisioning status, such as its success or failure for example.

The provisioning subsystem 227 collaborates with the lifecycle subsystem 229 in order to retrieve or update information relating to a component application. For example, the provisioning subsystem 227 can retrieve information to verify if a component application is installed, retrieve its version identifier and the like. Also, the provisioning subsystem 227 can update information, such as the version identifier for example, during a component application upgrade or downgrade.

The provisioning subsystem 227 collaborates with the communication subsystem 237 by registering as a coverage listener. Accordingly, the provisioning subsystem 227 can retrieve resources for a provisioned component application.

The provisioning subsystem 227 collaborates with the persistence subsystem 233 to facilitate access to persistent storage on the device. This collaboration facilitates storage of a provisioned component application and it associated resources. It also provides the ability to store and retrieve a scheduled component application provisioning task, and allows resuming already-started provisioning tasks.

The provisioning subsystem 227 collaborates with the control center 213 to be able to provide the user with provisioning status and progress information. The provisioning subsystem 227 further collaborates with the screen subsystem to be able to notify the user about downloading a deferred resource.

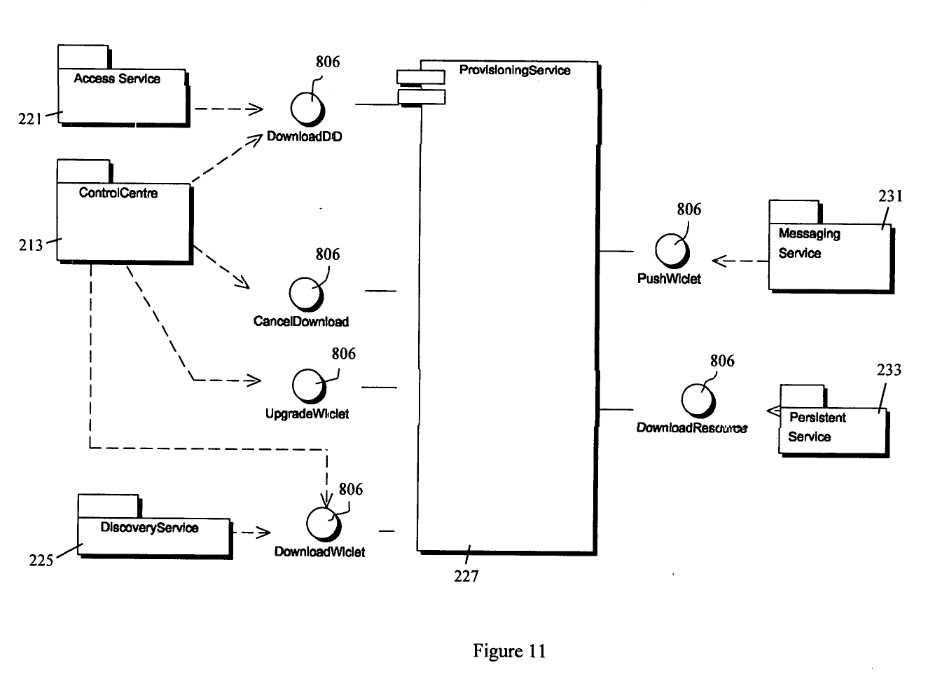

Referring to FIG. 11, interaction with the provisioning subsystem 227 is illustrated generally by numeral 1100. As illustrated, a number of different interfaces are provided for communication with different services and subsystems.

For example, a download interface 1102 facilitates communication between the provisioning subsystem 227, the access subsystem 221 and the control centre 213. The download interface facilitates downloading a specified component application from the application repository. A cancel download interface 1104 between the provisioning subsystem 227 and the control centre 213 facilitates cancellation of an already started component application download.

An upgrade component application interface 1106 between the provisioning subsystem 227 and the control centre 213 facilitates the actual upgrade process from a downloaded component application file.

A download descriptor interface 1108 between the provisioning subsystem 227 and the discovery subsystem 225 facilitates downloading a specified component application deployment descriptor.

A download resource interface 1110 between the provisioning subsystem 227 and the persistence subsystem 233 facilitates downloading a deferred resource such as an image or a sound, for example.

A push application interface 1112 between the provisioning subsystem 227 and the messaging subsystem 231 facilitates retrieval of a provisioning message transmitted by the gateway server 118.

Lifecycle Subsystem 229

The lifecycle subsystem 229 provides a registry of all installed component applications and information relating thereto. Such information includes, for example, name , version, URI (Uniform Resource Identifier), associated icon, corresponding gateway server address, administration policy, provisioning date and time, quarantine status, activity status (stopped, active or passive) and the like. The lifecycle subsystem 229 further administers component application on the device and is responsible for action such as start, stop, suspend, resume, delete, rename, and the like.

In order to facilitates implementing its responsibilities, the lifecycle subsystem 229 collaborates with control centre 213 and the persistence subsystem 227. The collaboration is achieved using requests.

The control centre 213 provides the lifecycle subsystem 229 with the ability to refresh an icon representing a component application and to notify the user about changes in component application's status. For example, the user can be provided with an indicator when a component application starts, stops, becomes passive, quarantined, and the like.

The persistence subsystem 227 provides lifecycle subsystem 229 with the ability to access persistent storage on the device 102. Therefore, the lifecycle subsystem 229 can store, retrieve, modify, and delete component application information. Further, if a component application needs to be suspended, the component application suspension data can be stored and retrieved. Yet further, a component application registry can be stored to and retrieved from the persistent storage on the device 102.

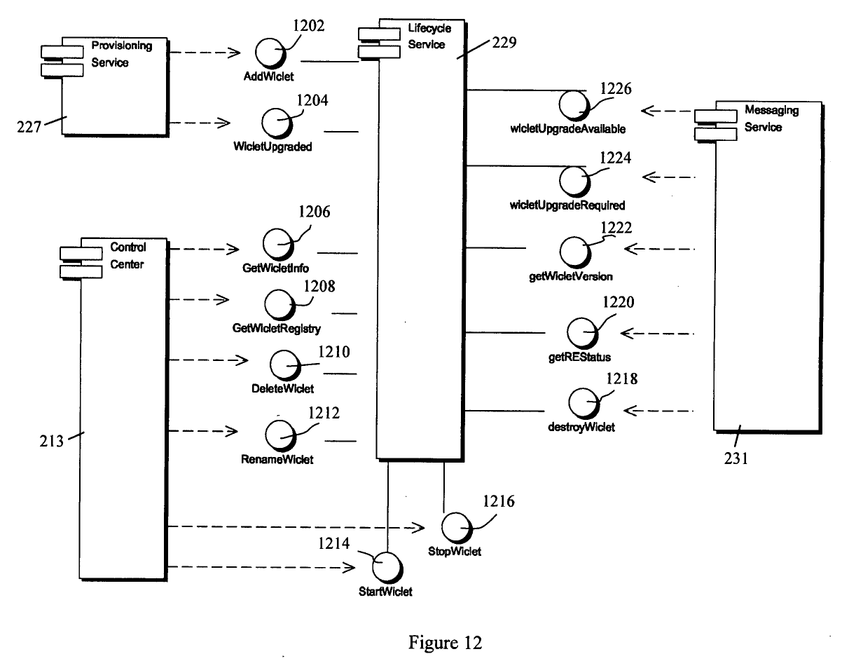

Referring to FIG. 12, interaction with the lifecycle subsystem 229 is illustrated generally by numeral 1200. As illustrated, the interaction uses a number of interfaces for providing communication with different services and subsystems.

An add-application interface 1202 and an application-upgrade interface 1204 facilitate communication between the lifecycle subsystem 229 and the provisioning subsystem 227. The add-application interface 1202 provides the ability to add an application to device registry once it has been provisioned, so that it may be accessed by the user. The application-upgrade interface 1204 provides the ability to update the device registry with updated information when a component application has been updated.

A get-information interface 1206, get-registry interface 1208, delete-application interface 1210, rename-application interface 1212, start-application interface 1214 and stop-application interface 1216 facilitate communication between the lifecycle subsystem 229 and the control centre 213. The get-information interface 1206 facilitates retrieval of information about a component application, such as name, version, status, and the like. The get-registry interface 1208 facilitates retrieval of a list of any or all installed components on the device and their associated information. The delete-application interface 1210 facilitates deleting a component application from the registry. The rename-application interface 1212 facilitates changing the name of a component application. The start-application interface 1214 facilitates activation of a component application and the stop-application interface 1216 facilitates exiting a component application.

A destroy-application interface 1218, runtime-status interface 1220, application-version interface 1222, upgrade-required interface 1224 and upgrade-available interface 1226 facilitate communication between the lifecycle subsystem 229 and the messaging subsystem 231. The destroy-application interface 1218 facilitates the removal of a component application and all of its associated data. The runtime-status interface 1220 facilitates retrieval of a list of all available component applications, as well as how much space they consume and the amount of available memory on the device 102. The application-version interface 1222 facilitates retrieval of a version identifier for a component application. The upgrade-required interface 1224 facilitates receipt of a notification from the gateway server 118 that an upgrade is required. The upgrade-available interface 1226 facilitates receipt of a notification from the gateway server that there is an available upgrade.

Messaging Subsystem 231

The messaging subsystem 231 provides non-trivial message queuing for incoming and outgoing messages. In the present embodiment, inbound messages refer to device bound messages, or messages to the RE and/or a component application. Outgoing messages refer to messages destined to one or more of the backend servers 108.

Accordingly, the messaging subsystem provides message compression and decompression so that the messages may be transmit to and from the device 102 while occupying a minimal amount of the device's bandwidth. Further, the messaging subsystem 231 distributes incoming device bound messages to appropriate RE service and/or component application.

In order to facilitate implementing its responsibilities, the messaging subsystem 231 collaborates with the communication subsystem 237 for sending messages, the security subsystem 235 for encrypting and authentication of messages if required, the metadata subsystem 219 for processing alerts and other services that process incoming messages. The collaboration is achieved by requests.

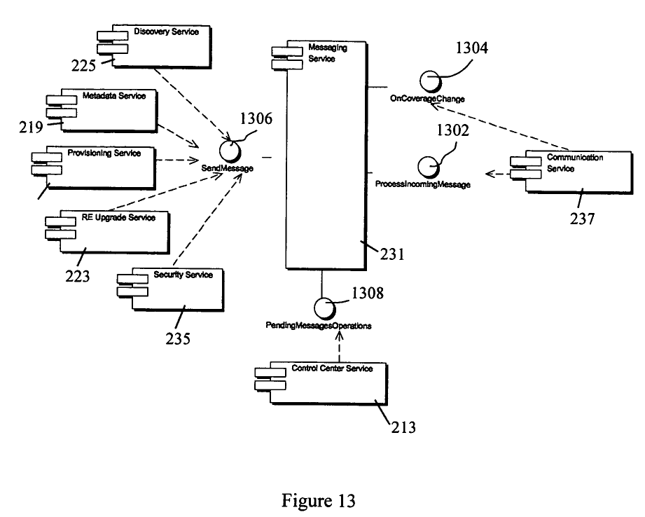

Referring to FIG. 13, interaction with the messaging subsystem 231 is illustrated generally by numeral 1300. As illustrated, the interaction uses a number of interfaces for providing communication with different services and subsystems.

For example, a incoming-message interface 1302 and a coverage-change interface 1304 facilitate communication between the messaging subsystem 231 and communication subsystem 237. The incoming-message interface 1302 facilitates distribution of incoming device bound messages to an appropriate RE service and/or component application. The coverage-change interface 1304 facilitates notification about important in-coverage and out-of-coverage events.

A send-message interface 1306 facilitates communication between the messaging subsystem 231 and any service or subsystem that can send messages, including the discovery subsystem 225, metadata subsystem 219, provisioning subsystem 227, RE container 223 and security subsystem 235. The send-message interface 1306 accepts messages from RE services or component applications and queues them for transmission from the RE.

A pending-operations interface 1308 facilitates communication between the messaging subsystem 231 and the control centre 213. The pending-operations interface 1308 facilitates operations to be executed on pending messages for a specific component application. Such operations may include, for example, deleting, counting and viewing of the pending messages. For instance, the control centre 213 might invoke this interface to view, delete or count pending messages in a queue.

Persistence Subsystem 233

The persistence subsystem 233 facilitates access to persistent storage on the device by any one of the services or subsystems as required.

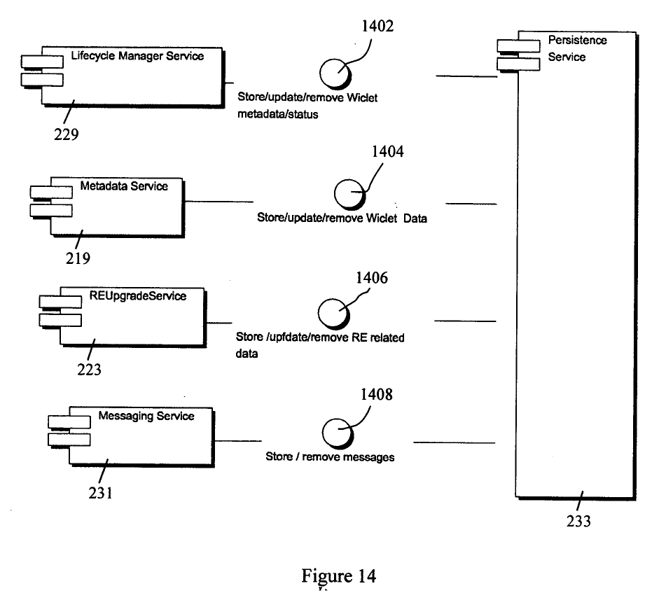

Referring to FIG. 14, interaction with the persistence subsystem 233 is illustrated generally by numeral 1400. As illustrated, the interaction uses a number of interfaces for providing communication with different services and subsystems.

For example, a RE-status interface 1406 facilitates communication between the persistence subsystem 233 and the RE container 223. The RE-status interface 1402 facilitates storage of a RE profile, including a version identifier, directory information, client administration policy, component application administration policies, security keys and upgrade availability information.

An application-status interface 1402 facilitates communication between the persistence subsystem 233 and the lifecycle subsystem 229. The application-status interface 1404 facilitates storage of component application profiles, including a version identifier, and metadata.

An application-data interface 1404 facilitates communication between the persistence subsystem 233 and the metadata subsystem 219. The application-status interface 1404 facilitates storage of persistent data components, persistent global data, component application resources and upgrade availability information.

An message interface 1408 facilitates communication between the persistence subsystem 231 and the messaging subsystem 233. The message interface 1404 facilitates storage of messages where required to accommodate a reliable messaging protocol. Outgoing messages may be stored pending delivery due to an out-of-coverage indicator. Incoming messages may be stored pending processing.

Security Subsystem 235

The security subsystem 235 facilitates inhibiting misuse of the device RE by a running component application. Given an associated component application administration policy, the security subsystem 235 can appropriately restrict access to a certain subset of RE services, such as, for example, access to a native device application. Since each component application may have its own administration policy, the security subsystem 235 can manage multiple component applications operating with different privileges.

The security subsystem 235 further facilitates message authentication and integrity. Specifically, the security subsystem 235 validates that messages received by RE have not been tampered with during transmission. The security subsystem 235 also verifies the origin of communicating party.

The security subsystem 235 uses a component application security profile, specified by a component application developer, to determine if messages between the component application and the gateway server 118 need to be encrypted and/or signed.

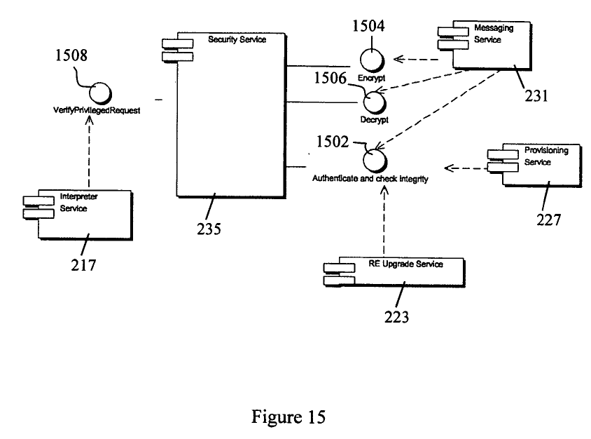

Referring to FIG. 15, interaction with the security subsystem 235 is illustrated generally by numeral 1500. As illustrated, the interaction uses a number of interfaces for providing communication with different services and subsystems.

For example, an integrity-check interface 1502 facilitates communication between the security subsystem 235, the messaging subsystem 231, the provisioning subsystem 227 and the RE container 223. The integrity-check interface 1502 facilitates verifying that a given message or native file-system file have not been altered during transmission and verifies the origin of the same.

An encrypt interface 1504 and a decrypt interface 1506 facilitate communication between the security subsystem 235 and the messaging subsystem 231. The encrypt interface 1504 facilitates encrypting message content if specified in a corresponding component application security profile or message definition. The decrypt interface 1506 facilitates decrypting message content if specified in a corresponding component application security profile or message definition.

A verify-request interface 1508 facilitates communication between the security subsystem 235 and the interpreter subsystem 217. The verify-request interface 1508 facilitates verification of a component application's request to the RE container 223 in accordance with the component application administration policy. A default trusted/untrusted component application administration policy specifies access rights for component applications that are not affected by their own profile.

Communication Subsystem 237

The communication subsystem 237 facilitates transmission and reception of messages to and from the device RE. The communication subsystem 237 further downloads resource and native file-format files from their corresponding repositories. Yet further, the communication subsystem 237 notifies interested RE services and subsystems about wireless coverage events, such as the device 102 going in and out of a wireless coverage area for example.

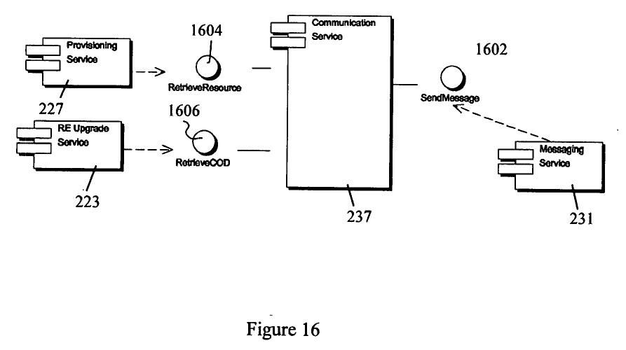

Referring to FIG. 16, interaction with the communication subsystem 237 is illustrated generally by numeral 1600. As illustrated, the interaction uses a number of interfaces for providing communication with different services and subsystems.

For example, a send-message interface 1602 facilitates communication between the communication subsystem 237 and the messaging subsystem 231. The send-message interface 1602 facilitates transmitting messages outside of the device 102.

A retrieve-resource interface 1604 facilitates communication between the communication subsystem 237 and the provisioning subsystem 227. The retrieve-resource interface 1604 facilitates the retrieval of component application resources.

A retrieve-file interface 1606 facilitates communication between the communication subsystem 237 and the RE container 223. The retrieve-file interface 1606 facilitates the retrieval of RE native file-system files.

Daemon 239

The daemon 239 is responsible for restarting the component application RE process whenever it stops due to a fatal exception.

Executing RE Operation

In order to execute a component application on the device 102, several processes are executed on the device. A RE process is the main process executed by the native RE. The RE process is active either in foreground or background mode. The RE process is started during the device's start-up sequence and hosts the following threads: UI; Messaging; Provisioning; CommIn; and CommOut.

The UI thread is the main thread for the RE Process, and is created when the RE process starts. The UI thread is responsible for launching the rest of the threads in the RE process, as required. Further, in the present embodiment, the UI thread is the only thread that works with native device UI components and processes user input. Accordingly, services or subsystems that require interaction with the user interface execute in the context of this thread.

Accordingly, the UI should not be blocked by time-consuming tasks. Tasks that may take time to be processed are scheduled for another thread, for example one of the Messaging, Provisioning, CommIn, or CommOut threads.

The UI thread wakes up if one of the following events occurs. A system event such as user input, scheduled task, input from another native device application and the like. An incoming component application message is received. A change occurs in the provisioning status, such as RE provisioning started, RE provisioning completed, component application provisioning started, component application provisioning completed, component application provisioning status check and the like.

The messaging thread is responsible for dispatching incoming messages to services that have been registered as message listeners. The messaging thread is also responsible for processing outgoing messages before they are sent to the communication subsystem 237 for transmission.

The messaging thread makes sure that the CommIn and CommOut threads are kept available as much as possible. Accordingly, time-consuming tasks are performed by the messaging thread.

The messaging thread wakes up if one of the following events occurs. An incoming message received by the CommIn thread. An outgoing message is available for transmitting to the gateway server 118.

The provisioning thread is responsible for executing provisioning tasks. Either the RE Container 223 or the provisioning subsystem 227 execute in this thread. The provisioning thread does not have a high priority and can afford to perform time consuming tasks. The provisioning thread ensures that the Messaging, CommIn, and CommOut threads are kept available as much as possible. Further, background provisioning tasks are executed by the provisioning thread.

The Provisioning thread wakes up if one of the following events occur. An incoming provisioning message is received. Resources are received by the communication thread. Native file-format files are received by the communication threads. The user initiates provisioning.

The CommIn thread is responsible for listening for incoming communication from gateway server 118. The communication thread is maintained in a state that listens for incoming connections, as much as possible. Any received data is forwarded to the messaging thread for further processing. The CommIn thread wakes up on an incoming server connection.

The CommOut thread is responsible for sending data to a destination server. Further, synchronous communication is performed within this thread. Both the messaging and communication subsystems 231 and 237 run in this thread. The CommOut thread is a low priority thread that takes some of the load off of the messaging thread.

The CommOut thread wakes up of one of the following events occurs. Outgoing message are queued for transmission. A provisioning request is made for a resource download. A provisioning request for a native file-system file download. The coverage status changes from in to out-of-coverage, or vice versa.

Further to the above, “threadless” services and subsystems are shared among different threads. Such services and subsystems require extra attention in order to avoid threading issues. Therefore, the “threadless” services and subsystems are designed to be thread-safe. The following are examples of services and subsystems that are considered to be “threadless”. The lifecycle subsystem 229 can be called from the UI, messaging, or provisioning threads. The security subsystem can be called from UI or messaging threads. The persistence subsystem 233 can be called from any thread.

Sample Flow Diagrams

This following provides a more detailed description of the system behaviour and illustrates how the services and subsystems described above collaborate for achieving this behaviour.

Initialization

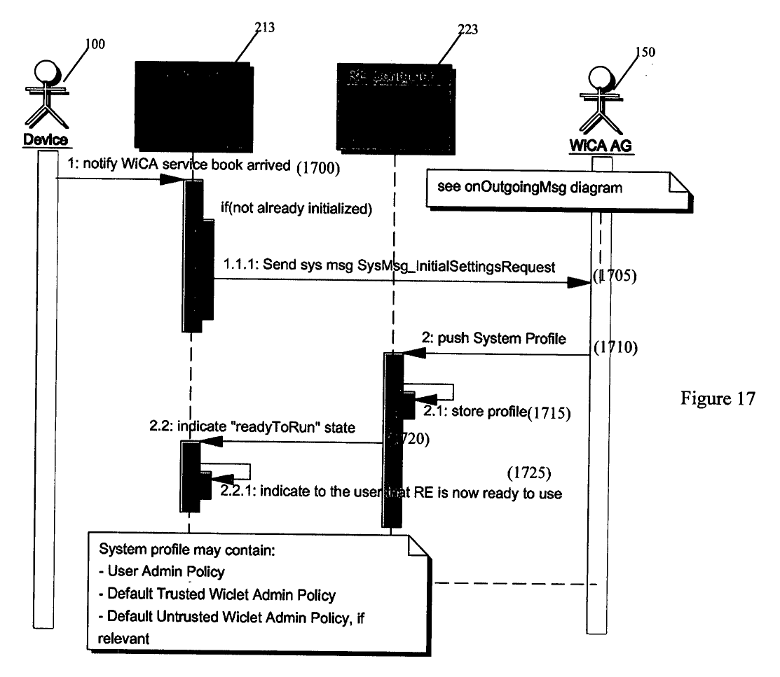

Referring to FIG. 17, a flow diagram illustrating initialization of the runtime environment is shown generally by numeral 1700. For ease of illustration, it has been assumed that the device is authorized to access the gateway server 118 and that the communication between the device 102 and gateway server 118 is unobstructed.

At step 1700, the device 102 receives initial communication parameters, such as the address of the gateway server 118 and the gateway server's public key for example. The parameters may be provided from a store within the device 102, or they may be pushed to the device 102 from the gateway (or other) server 106. Specifically, such information is received by the control centre 213.

In step 1705, the control centre 213 registers the RE and the device 102 with the gateway server 118 using the received initial parameters. In step 1710, the gateway server 118 delivers a system profile to the RE container 223. The system profile may include one or more of a user administration profile and default component application administration profiles for both trusted and untrusted component applications.

In step 1715, the RE stores the received profiles in the persistent store on the device 102. In step 1720, once the RE container 223 has received the required data from the gateway server 118, it informs the control centre 213 that it is ready for execution. In step 1725, the control centre 213 informs the user that the RE is ready to use.

Incoming Messages

The following describes a common sequence for receiving an incoming message, either a system message, service message or component application message. Any component application or subsystem that needs to process an incoming message registers as a message listener with the messaging subsystem 231 for the type of message in which it is interested. In one embodiment this may be achieved by registering with a message listener interface. The messaging subsystem acts as a distributor of messages and, as such, forwards messages to the corresponding registered message listener. Component application messages that have no registered message listener are stored compacted and unverified for processing when a listener is registered, for example when the component application is started.

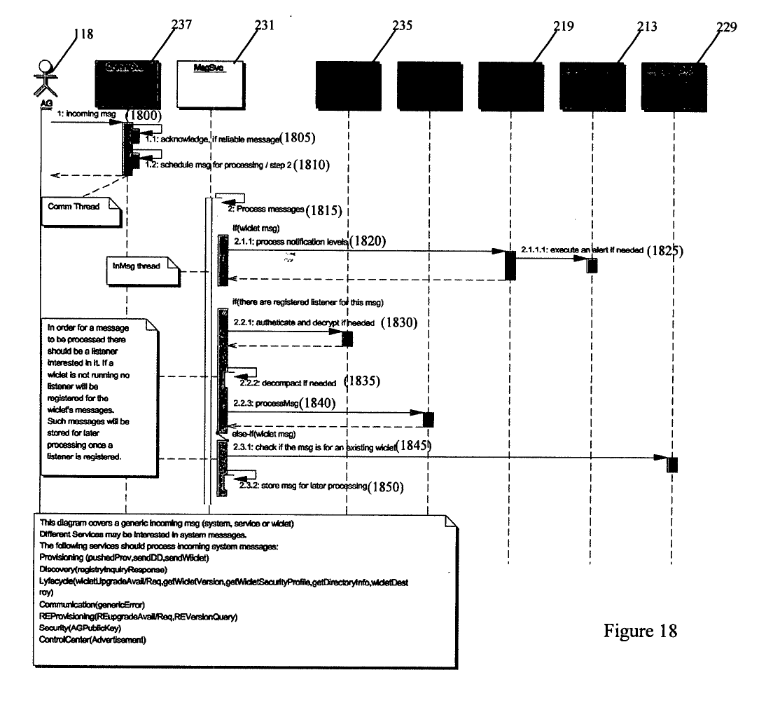

Referring to FIG. 18, a flow diagram illustrating a sample operation of the RE upon receipt of a message is shown. At step 1800, an incoming message from the gateway server 118 is received by the communication subsystem 237. If a reliable message scheme is being used, at step 1805 receipt of the message is acknowledged. At step 1810, the message is scheduled in a message queue for processing. Step 1800 to 1810 are executed in the CommIn thread.

The remaining steps, described as follows, are executed in the messaging thread. At step 1815, the message has passed through the message queue and is processed by the message subsystem 231. If it is determined that the message belongs to a component application on the device 102, at step 1820 the metadata subsystem 219 processes a notification level of the message. At step 1825, the control centre 213 provides an alert, if required.

If it is determined that there are one or more registered listeners for the message, at step 1830 the message is decrypted and authenticated if necessary. Further, at step 1835, the message is decompressed if necessary.

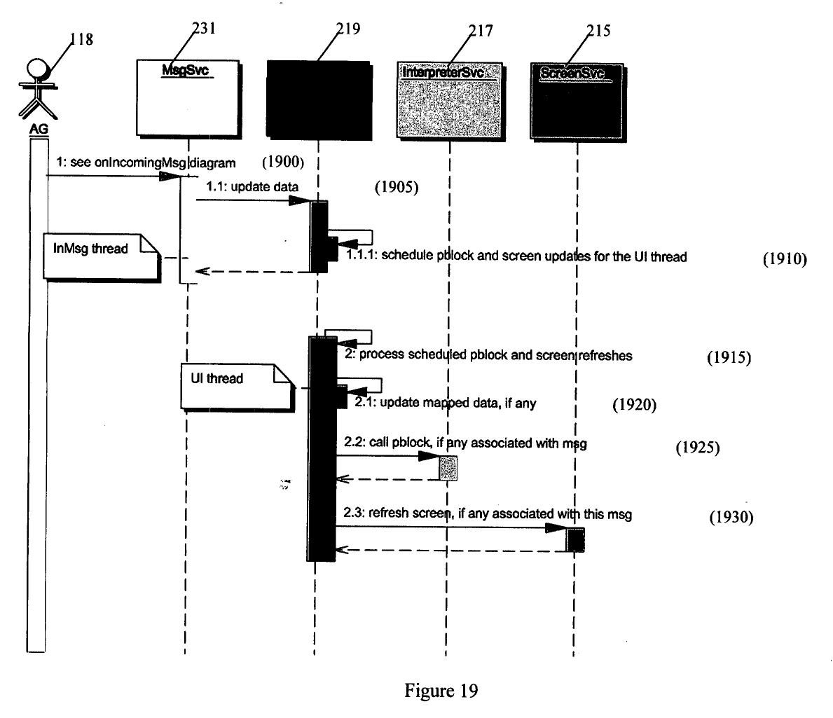

At step 1840 the message is processed by a corresponding message listener. As previously discussed, any of the services or subsystems of the RE that have an interest in receiving a particular message register as a message listener with the messaging subsystem 231. Accordingly, the message listener refers to a registered service or subsystem. Further steps for processing messages related to component applications will be described with reference to FIG. 19.

If it was determined that there are no message listeners registered for the received message and the message is a component application message, at step 1845 the messaging subsystem 231 verifies that the message is for an existing component application. At step 1850, the message is stored for later processing, once a corresponding listener is registered.

Incoming Component Application Messages

Referring to FIG. 19, a flow diagram illustrates, in more detail, the process of receiving a component application message. This flow diagram is an addendum to the flow diagram described with reference to FIG. 18.

In the present example, the metadata subsystem 219 has been registered as a subsystem interested in component application messages targeting the currently active component application. In order to reduce complexity of the example, it is assumed that the message is compatible with the version of the installed component application and does not cause any exceptions during processing.

In step 1900, the messaging subsystem 231 receives an incoming message as described with reference to FIG. 18. In step 1905, it is determined that the metadata subsystem 219 has registered as a message listener for the incoming message and the message is forwarded accordingly. In step 1910, in response to the message, the metadata subsystem 219 schedules appropriate script and screen updates to be executed for the UI thread.

In step 1915, the script and screen updates are executed by the UI thread as follows. In step 1920, any mapped data is updated if required by the execution of the incoming message. In step 1925, if a script is associated with the received message it is executed via a call to the interpreter subsystem 217. In step 1930, if a screen refresh is associated with the received message it is executed via a call to the screen subsystem 215.

Outgoing Messages

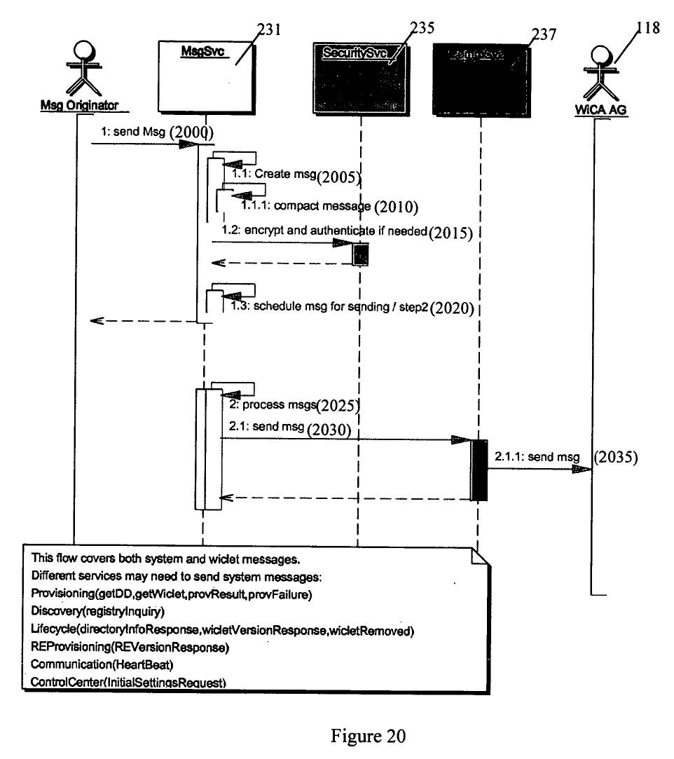

Referring to FIG. 20, a flow diagram illustrates the process of sending an outgoing message. In the present example, the sequence is the same for a system message as it is for component application message. Accordingly, in the present example, a message originator can be any service or subsystem that needs to send an outgoing message. For ease of explanation, an assumption is made that the message is sent successfully over-the-air to the gateway server 118.

In step 2000, a message request is initiated from the message originator and received by the messaging subsystem 231. At step 2005, the messaging subsystem 231 creates an outgoing message and in step 2010 compresses the content of the message as required. At step 2015, the messaging subsystem 231 collaborates with the security subsystem 235 for encrypting and authenticating the message as required. At step 2020, the messaging subsystem 231 schedules the message for transmission by the CommOut thread. All of the above steps are executed by the messaging thread.

At step 2025, the message reaches the front of the queue of the CommOut thread and is processed for transmission. At step 2030, the message is sent to the communication subsystem 237 for transmission to the gateway server 118 at step 2035.

Runtime Upgrade Required

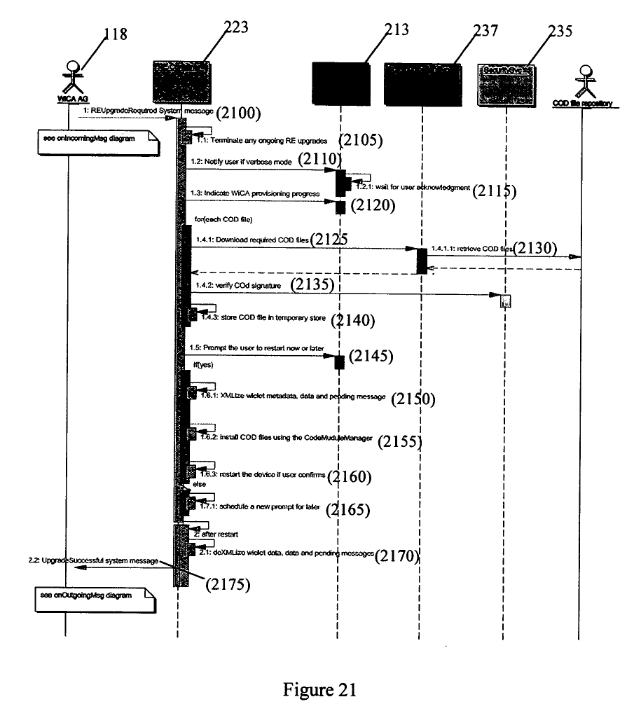

Referring to FIG. 21, a flow diagram illustrating the installation of an upgrade of the RE in response to a service message that an upgrade of the RE is required. For ease of explanation, it is assumed that the required native file-format files are successfully received, stored and installed on the device. Further, it is assumed that the user eventually agrees to restart the device 106.

In step 2100, a system message is received from the gateway server 118 indicating that an RE upgrade is required. The incoming message is handled as described with reference to FIG. 18. The following steps are executed by the component RE thread, unless otherwise noted.

At step 2105, any ongoing RE upgrades are terminated. If the device 102 is configured to receive RE upgrade in silent mode, the installation continues at step 2120. Silent mode indicates that the upgrade can be executed without explicit approval by the user of the device 102. If, however, the device is not configured to operate in silent mode, at step 2110, the user is notified of the need to upgrade the RE via the control centre 213. At step 2115, the control centre 213 waits until it receives a positive response from the user.

At step 2120, the RE container 223 provides the control centre 213 with a provisioning progress indicator. This indicator is updated throughout the installation.

For each native file-format file required by the RE upgrade, the following steps are performed. At step 2125, a download request for the required native file-format file is sent to the communication subsystem 237. The communication subsystem 237, in turn, obtains the required native file-format file from a native file-format file repository. At step 2135, the security subsystem 235 verifies the native file-format file signature and at step 2140 the native file-format file is stored in a temporary store. The above steps are repeated until all required native file-format files have been retrieved.

At step 2145, the control centre 213 prompts the user to restart the device 102. If the user chooses to restart the device immediately the installation continues at step 2150 and the RE container 223 converts all data, metadata and pending messages into a structured language. In the present example, the structured language is XML. At step 2155, the native file-format files are installed on the device 102 and at step 2160, the device 102 is restarted with confirmation from the user.

If the user did not choose to restart the device immediately, at step 2165, the prompt is scheduled to be presented to the user at a later time. It is assumed for the present example, that the user eventually chooses to restart the device.

At step 2170, once the device 102 has been restarted, the data that was converted to XML at step 2150 is reverted back to corresponding data, metadata and pending messages. At step 2175, a system message is send to the gateway server 118 confirming that the RE upgrade was completed successfully. The details of transmitting an outgoing message are described with reference to FIG. 20.

Start Component Application

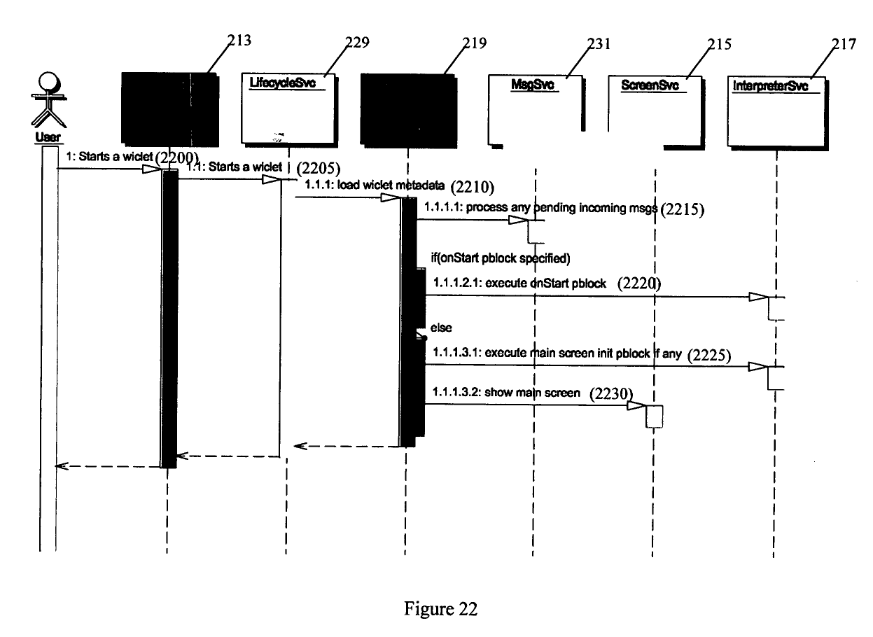

Referring to FIG. 22, a flow diagram illustrating the sequence of starting a component application installed on the device 102 is shown. For ease of explanation, the following assumptions have been made. The component application is already installed on the device 102. The component application metadata loads successfully. The component application is not being upgraded at the time of execution. The component application is not quarantined. There are no pending upgrade-required messages for the component application.

At step 2200, the user starts a component application by selecting its associated icon on the device's display. This action is identified by the control centre 213. At step 2205, the control centre 213 collaborates with the lifecycle subsystem 229 for starting the component application. At step 2210, the lifecycle subsystem 229 collaborates with the metadata subsystem 219 for loading the required metadata.

At step 2215, the metadata subsystem 219 collaborates with the messaging subsystem 231 for processing any messages pending for the component application. At step 2220, if a start-up script exists for the component application, it is executed by the interpreter subsystem 217. At step 2225, if no start-up script exists the interpreter subsystem 217 executes any screen initialization script associated with the component application's main screen. At step 2230, the screen subsystem 215 presents the main screen on the device 102.

User Initiated Provisioning

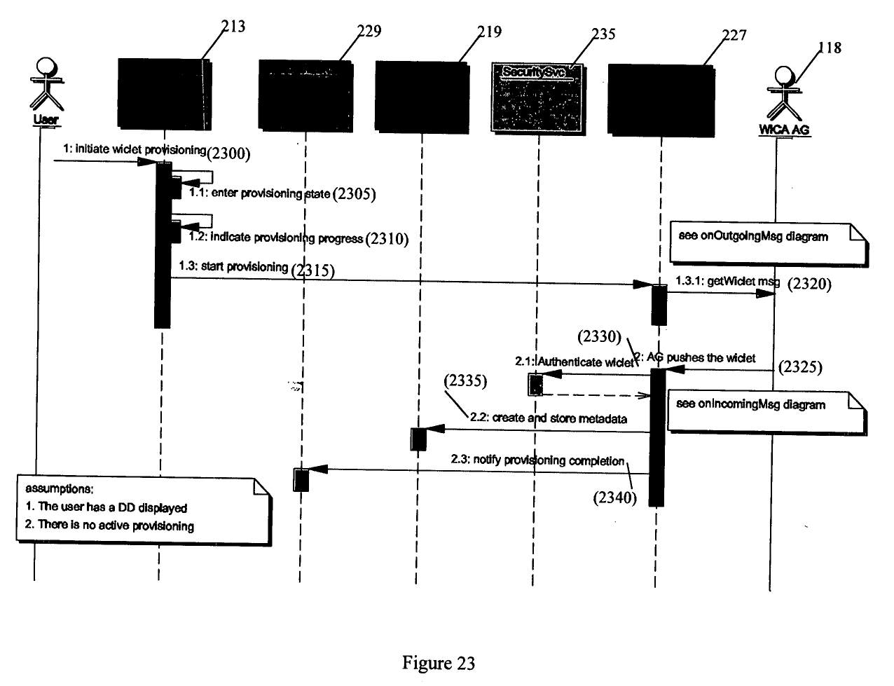

Referring to FIG. 23, a flow diagram illustrating a provisioning request initiated by a device user is shown. It will be appreciated that the flow will be different for a gateway server 118 initiated provisioning request. For ease of explanation, the following assumptions have been made. The user has already been provided with the download descriptor (DD) of the component application and has confirmed the provisioning request. No ongoing provisioning processes are occurring in the background. The DD signature has been validated successfully and the user is authorized to use the component application according to the user administration policy. The component application's signature has been validated successfully. The communication between the device 102 and the gateway server 118 is unobstructed. The gateway server 118 is aware of the existence of the requested component application.

At step 2300, the user initiates a provisioning request, which is processed by the control centre 213. At step 2305, the control centre 213 enters a provisioning state and at step 2310 initiates a provisioning progress indicator, which is maintained throughout the provisioning process. At step 2315 the provisioning subsystem 237 is contacted for initializing the provisioning process.

At step 2320, the provisioning subsystem 237 send an outgoing message to the gateway server 118 requesting the target component application. The outgoing message is sent as described with reference to FIG. 20.

At step 2325, the gateway server 3525 pushes the component application to the device 102 and it is received by the provisioning subsystem 237. At step 2330, the provisioning subsystem 237 collaborates with the security subsystem 235 for authenticating the component application. At step 2335, the provisioning subsystem 237 collaborates with the metadata subsystem 219 for creating and storing the required component application metadata.

At step 2340, the lifecycle subsystem 229 is informed that the provisioning is complete so that it can make the provisioned component application available to the user.

It will be appreciated that the flow diagrams present above are provided for illustrative purposes and are not intended to provide definitive methods for implementing the required steps.

Accordingly, the RE described above provides an environment in which to run component applications on a device executing a native RE. Specifically, interaction between the component application RE and the native RE has been described, as well as how the various components of the component application are handled by the component application RE.

Further, although the invention has been described with reference to certain specific embodiments, various modifications thereof will be apparent to those skilled in the art without departing from the spirit and scope of the invention as defined by the appended claims.

What is claimed is:

1. A device capable of executing component applications, the device comprising a native runtime environment for executing native applications and a component application runtime environment for executing the component applications, the component application runtime environment comprising:
a. a control centre for representing the component application runtime environment as a native application and for providing features offered by the device to the component applications;
b. a base services layer for providing basic device services to the component applications;
c. a messaging layer for transmitting messages to and from the component applications; and
d. an application layer for providing user interfaces for executing the component application.

2. The device of claim 1 further comprising a services layer for providing maintenance and lifecycle services for the component applications.

3. The device of claim 1, wherein the application layer further includes an access subsystem for facilitating access of native applications by the component application.

4. The device of claim 3, wherein the access subsystem comprises a plurality of plug-ins identifying accessible native applications.

5. The device of claim 3, wherein the access subsystem generates a native application handler for each native application that is accessed, the native application handler capable of communicating with a corresponding native application using native commands.

6. The device of claim 5, wherein the access subsystem provides data access to the native application, thereby providing the ability to share data between a component application and a native application.

7. The device of claim 6, wherein the access subsystem further converts data between data component format and a native application format for exchanging data.

8. The device of claim 5, wherein the access subsystem provides execution access to the native application, thereby providing the component application with the ability to share functionality with the native application.

9. The device of claim 1, wherein the base services layer further includes a communication subsystem for transmitting and receiving message between the device and a gateway server.

10. The device of claim 9, wherein the message layer includes a messaging subsystem having a plurality of registered listeners, the registered listeners comprising one or more services and subsystems provided by the component application runtime environment for being notified of a specific incoming message.

11. The device of claim 10, wherein the specific incoming message is automatically forwarded from the messaging subsystem to its registered listener.

12. The device of claim 9, wherein the communication subsystem has a plurality of registered listeners, the registered listeners comprising one or more services and subsystems provided by the component application runtime environment for being notified of a specific incoming message.

13. The device of claim 12, wherein the specific incoming message is automatically forwarded from the communication subsystem to its registered listener.

14. The device of claim 1, wherein the application layer further includes a lifecycle subsystem for managing component application information installed on the device.

15. A component application runtime environment for executing component applications on a device, the device comprising a native runtime environment for executing native applications, the component application runtime environment comprising:
a. a control centre for representing the component application runtime environment as a native application and for providing features offered by the device to the component applications;
b. a base services layer for providing basic device services to the component applications;
c. a messaging layer for transmitting messages to and from the component applications; and
d. an application layer for providing user interfaces for executing the component application.

16. A method for executing a component application in a component application runtime environment executing on a host device, the method comprising the steps of:
a. receiving a request for a target component application;
b. loading corresponding component application metadata into the component application runtime environment;
c. processing any message pending for the target component application;
d. running any available start-up scripts for the target component application; and
e. presenting a main screen component on the device screen.

17. The method of claim 16, further comprising the steps of:
a. receiving an incoming message at a communication subsystem;
b. processing the incoming message at the communication subsystem; and
c. forwarding the processed message to a service or subsystem that has registered as a message listener for the received message.

18. The method of claim 17, further comprising the step of at least one of decrypting, decompressing and authenticating the message.

19. The method of claim 17, wherein, if the message has no registered listeners, the message is stored for later access.

20. The method of claim 17, further comprising the step of providing an alert in response to the message.

21. The method of claim 17, further comprising the step of executing at least one of a predefined script and a screen refresh.

22. The method of claim 21, further comprising the step of updating metadata corresponding with the message.
